(19) United States
(12) Patent Application Publication
(10) Pub. No.: US 2003/0143356 A1
(43) Pub. Date: Jul. 31, 2003

(54) Carbon nanotube for electron emission source and manufacturing method therefor

(76) Inventor: Mitsuaki Morikawa, Mie (JP)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/274,703

(22) Filed: Oct. 18, 2002

(30) Foreign Application Priority Data
Oct. 19, 2001 (JP) 322205/2001

(51) Int. Cl. B32B 1/08

(52) U.S. Cl. 428/36.91

(57) ABSTRACT

In a carbon nanotube for an electron emission source, the carbon nanotube has a cylindrical shape formed from a plurality of graphite layers. The graphite layer is made of a six-membered ring of carbon. The outer diameter of the cylinder is 0.6 to 100 nm. The diameter of a hollow portion formed along the axis of the cylinder is 0.1 to 0.9 times the outer diameter of the cylinder. The hollow portion has an open distal end portion.

### BACKGROUND OF THE INVENTION

The present invention relates to an electron emission source and, more particularly, to a field emission type electron emission source using a carbon nanotube and a manufacturing method therefor.

As shown in FIGS. 6A and 6B, a carbon nanotube (to be referred to as a “CNT” hereinafter) has a closed structure in which a five-membered ring is formed on the distal end portion of a tube-like structure formed by closing a single graphite layer into a cylindrical shape, which is composed of a plurality of six-membered rings (benzene rings) of carbon forming a two-dimensional flat mesh structure. It is known that the outer diameter of a single-layer CNT is as small as 0.5 to several nm. When an electric field is applied to such a CNT, electrons can be emitted from the very thin distal end portion on which the electric field is concentrated (this is called a field electron emission phenomenon). Note that FIG. 6A shows the overall structure, and FIG. 6B is an enlarged view of the distal end portion.

Recently, this CNT has attracted a great deal of attention as an electron emission source for an FED (Field Emission Display) and vacuum fluorescent display. Electron emission sources in various forms that use the field electron emission phenomenon of CNTs have been proposed (e.g., Japanese Patent Laid-Open No. 11-167886).

As described above, however, since the distal end portion of a CNT has a closed structure formed by a five-membered ring composed of five carbon atoms, when it is used as a field emission type electron emission source, a several tens of thousands of V/m are required for field emission of electrons in a number sufficient to make the CNT function as an electron emission source for an FED or vacuum fluorescent display.

In order to emit a sufficient number of electrons, therefore, it is necessary to set a high electron extraction voltage to be applied between the electron emission source formed from the CNT and the electron extraction electrode or decrease the distance between the CNT distal end portion (electron emission region or “site”) and the electron extraction electrode to about 20 μm. As a consequence, a power circuit for electron emission becomes expensive. Alternatively, a strict assembly precision is required for an assembly process. This becomes a factor that increases the cost of an FED or vacuum fluorescent display.

### SUMMARY OF THE INVENTION

It is an object of the present invention to increase the number of electrons emitted from a field emission type electron emission source using CNTs without increasing the electric field strength.

In order to achieve the above object, the present invention uses CNTs having open distal end portions to form an electron emission source.

According to an aspect of the present invention, there is provided a carbon nanotube for an electron emission source, wherein the carbon nanotube has a cylindrical shape formed from a plurality of graphite layers, the graphite layer being made of a six-membered ring of carbon, and an outer diameter of the cylinder is 0.6 to 100 nm, a diameter of a hollow portion formed along an axis of the cylinder is 0.1 to 0.9 times the outer diameter of the cylinder, and the hollow portion has an open distal end portion.

According to another aspect of the present invention, there is provided a material for an electron emission source including a plurality of carbon nanotubes, wherein at least 10% of the carbon nanotubes has a cylindrical shape formed from a plurality of graphite layers made of a six-membered ring of carbon, and a diameter of a hollow portion formed along an axis of the cylinder is 0.1 to 0.9 times the outer diameter, and the hollow portion has an open distal end portion.

According to still another aspect of the present invention, there is provided an electron emission source having a plurality of carbon nanotubes arrayed on a substrate, wherein at least 10% of the carbon nanotubes is designed such that a diameter of a hollow portion formed along an axis of the cylinder is 0.1 to 0.9 times the outer diameter, and the cylinder has an open distal end portion.

According to still another aspect of the present invention, there is provided a method of manufacturing an electron emission source, comprising the step of generating a deposit containing a carbon nanotube by causing arc discharge between carbon electrodes facing each other in an inert gas atmosphere, and the step of heat-treating the deposit in an atmosphere of an oxygen concentration of 5 to 30 vol % at a temperature of 520 to 850° C. for 5 to 20 min.

According to still another aspect of the present invention, there is provided a method of manufacturing an electron emission source, comprising the step of placing a base material made of a metal including at least iron in a material gas atmosphere containing a gas made of a carbon compound, and causing a chemical change in the material gas by externally applying energy thereto, thereby growing a carbon nanotube on a surface of the base material, and the step of heat-treating the carbon nanotube covering the surface of the base material in an atmosphere containing an oxygen concentration of 5 to 30 vol % at a temperature of 520 to 820° C. for 5 to 20 min.

That is, a CNT for an electron emission source according to the present invention has a cylindrical shape formed from a plurality of graphite layers made of six-membered rings of carbon. The diameter of a hollow portion formed along the axis of the cylinder is 0.1 to 0.9 times the outer diameter of the cylinder. The distal end portion of the hollow portion is open. In addition, the outer diameter of the cylinder is preferably 0.6 to 100 nm.

In the present invention, electrons are emitted from the open distal end portion of the CNT. More specifically, the opening portion of the open distal end portion of the CNT has a plurality of six-membered rings in place of a five-membered ring, and electron emission seems to occur at carbon forming these six-membered rings. If, therefore, the electric field strength remains the same, a larger number of electrons can be obtained than in the case wherein the distal end of the CNT is closed with a five-membered ring. It is empirically known that most CNTs having an outer diameter of 0.6 nm or more become multilayer CNTs.

In this case, if a CNT having an outer diameter of less than 0.6 nm is used as an electron emission source, sufficient electron emission cannot be realized. In addition, the CNT preferably has an outer diameter of 0.6 nm or more to have sufficient mechanical strength when it serves as an electron emission source. In manufacturing a CNT, the lower limit of the outer diameter is 0.6 nm.

If the outer diameter exceeds 100 nm, the distal end of the CNT becomes flat. This makes it difficult to cause electron emission by concentration of an electric field.

As a consequence, such a CNT cannot be used as an electron emission source.

If the diameter of the hollow portion (hollow core) of a CNT is too small, the CNT becomes fibrous, resulting in difficulty in obtaining a cylindrical shape. In contrast, if the diameter is too large, the wall of the CNT becomes excessively thin, and it is difficult to obtain sufficient physical strength when it is used as an electron emission source. If, for example, the diameter of the hollow core is less than 0.1 times the outer diameter of the cylinder, the central portion is filled with carbon atoms. That is, the CNT cannot have a hollow portion. Consequently, no opening portion can be formed in the distal end of the CNT, and it is difficult to realize sufficient electron emission when it is used as an electron emission source. If the diameter of the hollow core exceeds 0.9 times the outer diameter of the cylinder, it becomes difficult to cause electron emission. In addition, the wall of the CNT becomes too thin, and hence sufficient mechanical strength cannot be obtained. Therefore, a better result can be obtained by setting the diameter of the hollow core to 0.1 to 0.9 times, preferably 0.2 to 0.9 times (the wall thickness is 10 to 80% of the outer diameter of the cylinder) the outer diameter of the cylinder.

In consideration of the manufacture, the length of the CNT is preferably 100 times or more its outer diameter, more preferably 1,000 times or more.

An electron emission source material and electron emission source according to the present invention include a plurality of CNTs, and at least 10% of the CNTs has the above characteristics.

If 10% or more of all the CNTs does not have the above characteristics, a sufficient emission amount (the number of electrons emitted by field emission) cannot be ensured when the resultant structure is used as an electron emission source.

A method of manufacturing an electron emission source according to the present invention comprises the step of generating a deposit containing a CNT by causing arc discharge between carbon electrodes facing each other in an inert gas atmosphere, and the step of heat-treating the deposit in an atmosphere of an oxygen concentration of 5 to 30 vol % at a temperature of 520 to 850° C. for 5 to 20 min.

Another method of manufacturing an electron emission source according to the present invention may comprise the step of placing a base material made of a metal including at least iron in a material gas atmosphere of a gas made of a carbon compound, and causing a chemical change in the material gas by externally applying energy thereto, thereby growing a CNT on a surface of the base material, instead of the step of generating the deposit by arc discharge, and the step of heat-treating the CNT covering the surface of the base material in an atmosphere of an oxygen concentration of 5 to 30 vol % at a temperature of 520 to 820° C. for 5 to 20 min.

In a method of manufacturing an electron emitter according to the present invention, heat treatment of a CNT is performed in an atmosphere of a predetermined oxygen concentration at a predetermined temperature for a predetermined period of time to remove the distal end portion of the CNT extending in the atmosphere containing oxygen, thereby forming an opening portion.

In order to burn the distal portion of a CNT to form an opening portion, an atmosphere of at least an oxygen concentration of 5 vol % is required. However, in an atmosphere in which the oxygen concentration exceeds 30 vol %, the CNT is burnt more than necessary.

Likewise, if the temperature in heat treatment is lower than 520° C., the distal end portion of the CNT is burn insufficiently. If the temperature exceeds 850° C., the CNT is burnt out.

Note that the method of “causing a chemical change in the material gas by externally applying energy thereto, thereby growing a carbon nanotube on a surface of the base material” includes the CVD (Chemical Vapor Deposition) method and plasma CVD method, in practice, and “by externally applying energy” indicates, for example, heating the base material in a predetermined material gas atmosphere or introducing microwaves into the material gas atmosphere.

### BRIEF DESCRIPTION OF THE DRAWINGS

FIGS. 1A to 1E are views showing the arrangement of a vacuum fluorescent display (image tube) using an electron emission source according to the first embodiment of the present invention;

FIGS. 2A and 2B are conceptual views showing an electron emission source according to the second embodiment of the present invention;

FIG. 3 is an electron micrograph of the electron emission source of the second embodiment;

FIG. 4 is an electron micrograph obtained by photographing a coating on the surface of an electron emission source from above according to the third embodiment of the present invention;

FIG. 5 is an electron micrograph obtained by obliquely photographing a coating on the surface of an electron emission source according to the third embodiment; and

FIGS. 6A and 6B are views showing a carbon nanotube forming a conventional electron emission source.

### DESCRIPTION OF THE PREFERRED EMBODIMENTS

The embodiments of the present invention will be described below with reference to the accompanying drawings.

[First Embodiment]

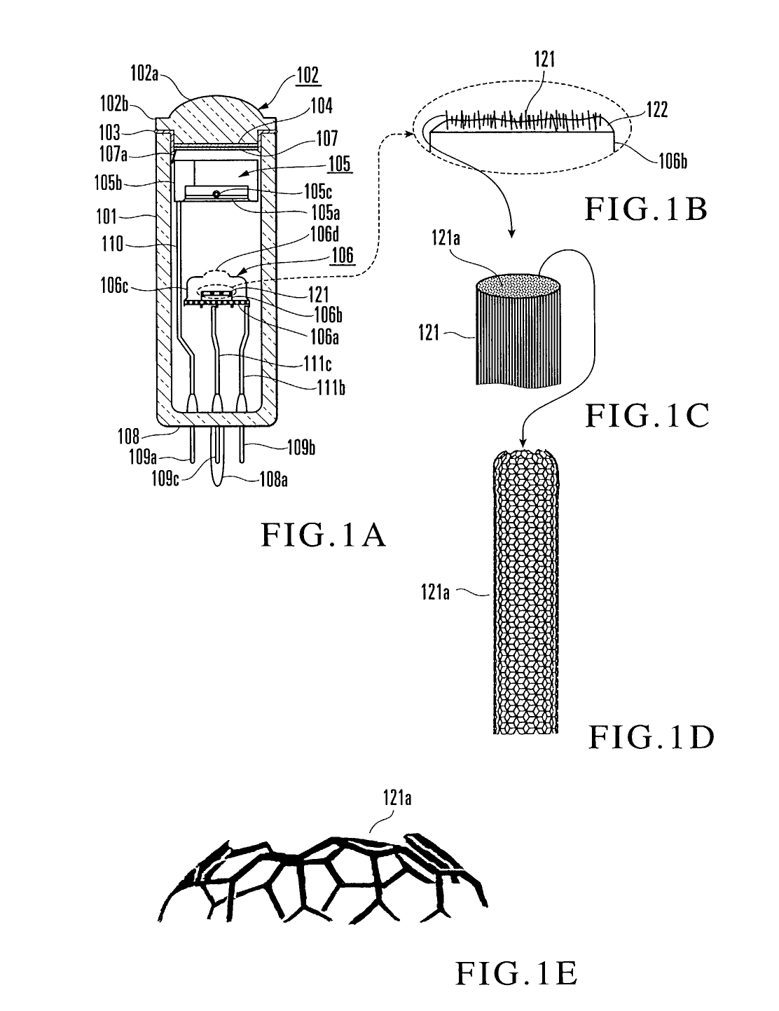

FIGS. 1A to 1E show the arrangement of a vacuum fluorescent display (image tube) using an electron emission source according to an embodiment of the present invention.

This image tube is designed such that a face glass 102 is bonded/fixed to a cylindrical glass bulb 101 with low-melting frit glass 103 to form a vacuum vessel (envelope). In this vacuum vessel, a phosphor screen 104, an anode electrode assembly 105, and a cathode assembly 106 functioning as an electron emission source are arranged.

Note that in the manufacturing process for this image tube, the face glass 102 on which the phosphor screen 104 is formed is bonded/fixed to the glass bulb 101 after the anode electrode assembly 105 and cathode assembly 106 are arranged in the glass bulb 101.

A spherical portion 102a in the form of a convex lens is formed on the front surface side of the face glass 102, and a collar-like stepped portion 102b is formed on the edge of the face glass 102. The phosphor screen 104 is formed on the principal plane of the inner surface of the face glass 102. An Al metal-back film 107 is formed on the upper surface of the phosphor screen 104.

In this case, the phosphor screen 104 is formed by print coating, to a thickness of about 20 μm, a paste obtained by dissolving a white phosphor, e.g., a Y₂O₂S:Tb+Y₂O₃:Eu mixed phosphor, in a solvent, and drying the paste. The Al metal-back film 107 is formed to a thickness of about 150 nm by vapor deposition.

A concave portion (not shown) is formed in part of the peripheral portion of the inner surface of the face glass 102. The phosphor screen 104 is not formed in this concave portion and only the Al metal-back film 107 is formed therein.

One end side of a contact piece 107a that electrically connects the Al metal-back film 107 and the anode electrode assembly 105 is inserted into the concave portion and bonded/fixed thereto with a conductive adhesive made of a mixture of carbon or silver and frit glass. This contact piece 107a is a conductive member formed by, for example, press-molding a thin stainless steel plate having elastic force. The other end side of the contact piece 107a extends toward the inner wall surface of the glass bulb 101 and comes into contact with a cylindrical anode 105b forming part of the anode electrode assembly 105.

This anode electrode assembly 105 is comprised of a ring-like anode 105a formed by, for example, rounding a metal wire (diameter: 0.5 mm) made of a stainless steel member into a ring-like shape and a cylindrical anode 105b formed by winding a rectangular stainless steel plate (thickness: 0.01 to 0.02 mm) around the outer surface of the ring-like anode 105a and fixing the overlapping portions at two points by welding or the like.

The ring-like anode 105a of the anode electrode assembly 105 is welded to the distal end portion of an anode lead 110 at a predetermined position. In addition, the inner portion of the cylindrical anode 105b is welded/fixed to the distal end of the anode lead 110. A Ba getter 105c is mounted/fixed on a portion of the ring-like anode 105a by welding or the like. Note that FIG. 1A shows no cross-sections of the anode electrode assembly 105 and lead pins 109a to 109c.

The lead pins 109a to 109c extend through a stem glass 108 forming the bottom portion of the glass bulb 101, and an exhaust pipe 108a is integrally formed with the stem glass 108. On this stem glass 108, the anode lead 110 is fixed to the distal end portion of the lead pin 109a by welding, and the cylindrical anode electrode assembly (electron accelerating electrode) 105 is fixed to the distal end of the anode lead 110 by welding.

The lead pins 109b and 109c also extend through the stem glass 108, and cathode leads 111b and 111c are fixed to the distal end portions of the lead pins 109b and 109c by welding. The cathode assembly 106 is fixed to the distal end portions of the cathode leads 111b and 111c by welding.

This cathode assembly 106 is configured as follows.

First of all, an electrode (conductive plate) 106b is placed on the middle portion of a ceramic substrate 106a. A columnar graphite member (emitter) 121 formed from a carbon nanotube (CNT) assembly as indicated by the enlarge view of FIG. 1B is fixed on an area having a diameter of about 3 mm on the upper surface of the electrode 106b with an conductive adhesive 122 such that the longitudinal direction of the columnar graphite member 121 almost coincides with the direction of the phosphor screen 104.

A housing 106d having a mesh portion 106e made of a conductor is placed on the ceramic substrate 106a to cover the electrode 106b and columnar graphite member 121. This housing 106d is formed by press-molding a stainless steel plate having a thickness of about 100 μm. The mesh portion 106e has, for example, a length of about 6 mm, a width of about 4 mm, and a height of about 1.25 mm. This mesh portion 106e is spaced apart from the emitter 121 made of a columnar graphite member by about 0.5 to 1 mm and functions as an electron extraction electrode.

Note that the mesh portion 106e may be flat.

As described above, in the vacuum fluorescent display (image tube), by applying voltages from an external circuit to the lead pins 109b and 109c electrically connected to the emitter (columnar graphite member) 121 and electron extraction electrode (mesh portion) 106e, electrons can be extracted from the emitter 121. In addition, a high voltage is applied from the external circuit to the lead pint 109a, and the path extending from the anode lead 110 to the contact piece 107a via the anode electrode assembly 105 (cylindrical anode 105b) is rendered conductive, thereby applying the high voltage to the Al metal-back film 107. In this state, the emitted electrons are accelerated by the cylindrical anode 105b to pass through the Al metal-back film 107 and collide with the phosphor screen 104. As a consequence, the phosphor forming the phosphor screen 104 is excited by the electron bombardment, and a luminescent color corresponding to the phosphor is displayed on the front surface side (face glass 102 side) through the face glass 102.

FIG. 1C shows the columnar graphite member 121. As shown in FIG. 1C, this columnar graphite member 121 has a structure in which needle-like CNTs 121a, each having a length of several μm to several mm, are assembled in almost the same direction.

FIG. 1D schematically shows the structure of the CNT 121a forming the columnar graphite member 121. For example, as shown in FIG. 1D, at least 10% of the CNTs 121a forming the electron emission source according to this embodiment is completely graphited into a cylindrical shape. The wall of the resultant structure is formed from a plurality of graphite layers made of six-membered rings of carbon (for the sake of simplicity, an illustration of the multilayer structure composed of a plurality of graphite layers is omitted from FIG. 1D). This cylinder (multilayer CNT) has an outer diameter of about 4 to 50 nm and a length of the order of 10 μm. The hollow portion formed inside the cylinder along the axis of the cylinder has a diameter 0.1 to 0.9 times the outer diameter.

FIG. 1E shows the distal end portion of the CNT 121a. As shown in FIG. 1E, the distal end portion of the CNT 121a is open.

When a voltage is applied between the emitter 121 including such CNTs 121a and the electron extraction electrode (mesh portion) 106e, electrons are emitted from the distal end portions of the CNTs 121a on which an electric field is concentrated by the field electron emission phenomenon. With the same electric field strength, a larger number of electrons can be obtained from an open CNT than from a conventional CNT having a structure in which the distal end portion is closed by a five-membered ring. This is because a plurality of six-membered rings exist in the distal end portion of the CNT 121a, and electron emission occurs at carbon atoms constituting these six-member rings.

A method of manufacturing the emitter (columnar graphite member) 121 including the above CNTs will be described next.

First of all, two carbon electrodes are arranged at a distance of about 1 to 2 mm from each other in an inert gas atmosphere such as an argon atmosphere adjusted to atmospheric pressure or lower, and more specifically, a pressure of 1 to 0.1 Pa, and a DC current of 40 to 100 A is made to flow between these electrodes to cause DC arc discharge. The energization time is set to 2 to 20 sec.

The carbon atoms on the anode side then evaporate due to the DC arc discharge, and a columnar deposit having almost the same diameter as that of the anode carbon electrode is formed on the carbon electrode end face on the cathode side.

This columnar deposit is comprised of two regions, i.e., a hard shell on the outside and a fragile black core on the inside. The core on the inside is made of a fibrous tissue extending in the longitudinal direction of the deposit. A columnar graphite member can be obtained by cutting this fibrous core from the hard shell on the outside. Note that the hard shell on the outside is polycrystalline graphite.

The columnar graphite member obtained in this manner is composed of carbon nanopolyhedorons and a plurality of CNTs aligned in the longitudinal direction of the deposit. Each CNT has a length of about 0.6 to 100 μm and is formed such that a single graphite layer is closed into a cylindrical shape or a plurality of graphite layers are nested and stacked on each other, and each graphite layer is closed into a cylindrical shape to form a coaxial multilayer structure. Either CNT has a structure in which a cavity (hollow) is formed in the central portion to form a cylindrical shape, and its distal end portion is closed by a five-membered ring.

The columnar graphite member including the CNT is heat-treated in an atmosphere of an oxygen concentration of 5 to 30 vol % at a temperature of 520 to 850° C. for 5 to 20 min. With this heat treatment, only the distal end portion of the CNT is burnt to form an opening portion. This is because the five-membered ring on the distal end portion of the CNT is lower in binding energy than the six-membered rings on the remaining portions, and hence the five-membered ring on the distal end, which binds to oxygen relatively easily, is burnt first.

Note that with this heat treatment, carbon nanopolyhedorons contained in the CNT and columnar graphite member can be burnt and removed.

In this case, if the oxygen concentration is lower than 5 vol %, the distal end portion cannot be burnt even at a higher temperature. If the oxygen concentration is higher than 30 vol %, portions other than the distal end portion of the CNT are burnt. If the temperature is lower than 520° C., the distal end portion cannot be burnt. If the temperature exceeds 850° C., portions other than the distal end portion are burnt. If the heating time is equal to or shorter than 5 min, the distal end portion cannot be sufficiently burnt. If the CNT is heated for 20 min or more, portions other than the distal end portion may be burnt. Therefore, as the temperature rises, the heating time shortens, and vice versa. Likewise, as the total pressure or oxygen concentration of the atmosphere including oxygen increases, since burning is accelerated, the heating temperature and heating time must be decreased.

Assume that the conditions for the above heat treatment are set such that in an atmosphere with an oxygen concentration of 5 to 30 vol %, the heating temperature is 600 to 800° C. and the heating time is 10 to 15 min. In this case, even if either a glass substrate or a metal substrate is used, heat treatment can be properly done.

With the use of a columnar graphite member as an emitter, which includes a CNT whose distal end portion is opened in the above process, electrons can be emitted 3 to 10 times larger in number than that in the case wherein the conventional CNT is used, when electrons are extracted at the same potential (i.e., the same voltage as that in the prior art is applied to the lead pins 109b and 109c).

[Second Embodiment]

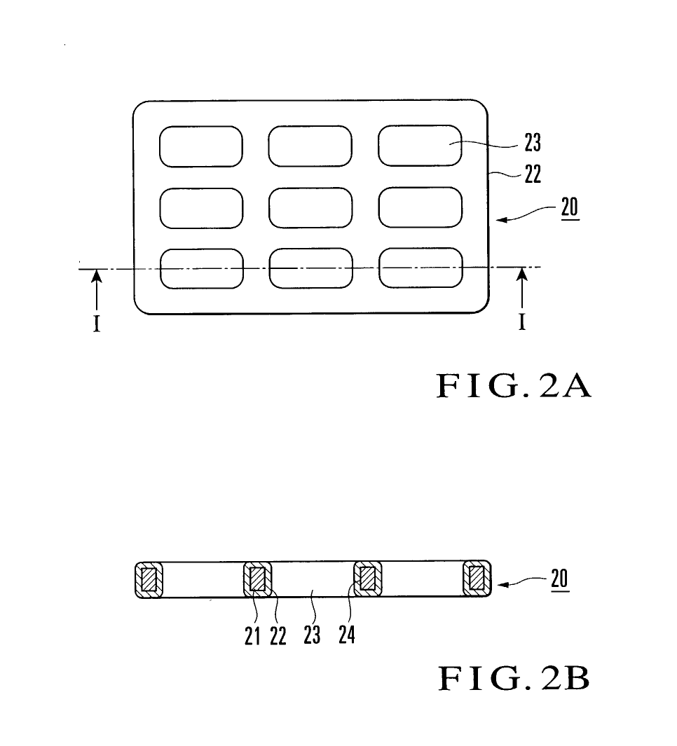

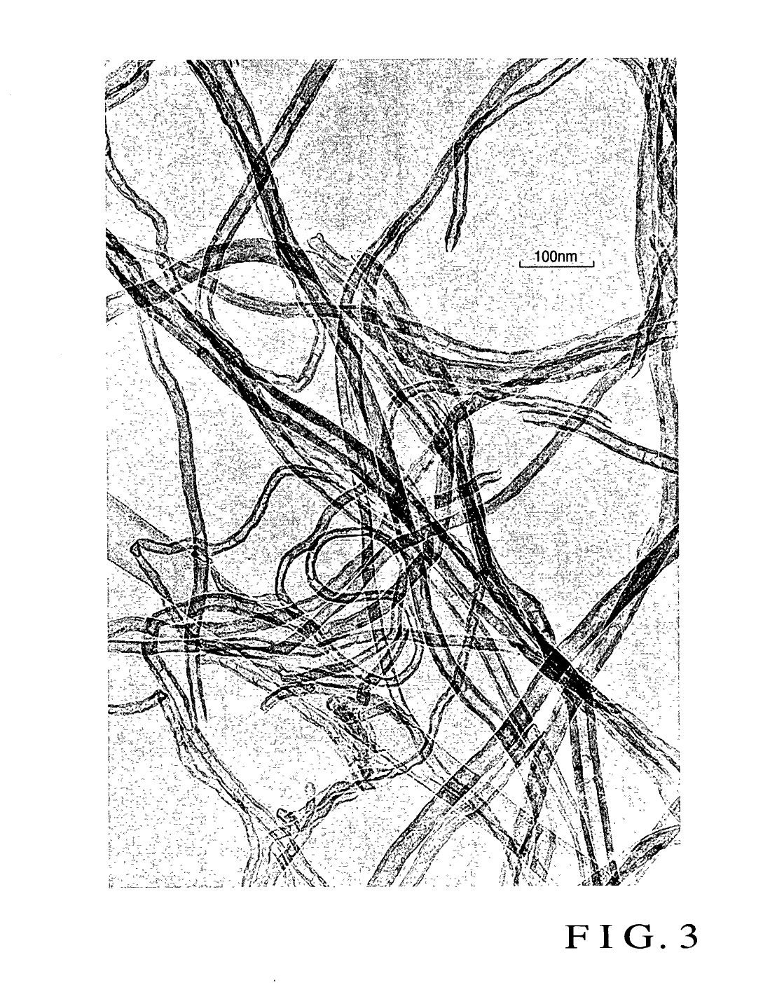

An electron emission source according to the second embodiment of the present invention will be described next with reference FIGS. 2A, 2B, and 3.

FIGS. 2A and 2B show the arrangement of an electron emission source according to this embodiment. As shown in FIGS. 2A and 2B, an electron emission source 20 is designed such that carbon nanotubes are arranged on the surface of a substrate 21 having many through holes 23 and a through hole wall 24.

The substrate 21 is made of a material serving as a catalyst for the generation of a CNT, e.g., pure iron or an alloy containing iron. In this case, the substrate 21 has a thickness of 0.05 to 0.20 mm, and has the through holes 23, each having a width of 0.05 to 0.2 mm, arranged in the form of a matrix, thus having a lattice-like shape.

CNTs, each having a thickness of about 0.6 to 100 nm and a length of about 1 μm or more to less than 100 μm, are almost uniformly formed on the surface of the substrate 21 and the through hole wall 24 to a thickness of 10 to 30 μm while curling or being intertwined.

This CNT coating is formed from a carbon nanotube having a single-layer structure formed by a single graphite layer which is closed into a cylindrical shape or a CNT having a coaxial multilayer structure in which a plurality of graphite layers are nested and stacked on each other, and each graphite layer is closed into a cylindrical shape. At this time, the ratio of multilayer CNTs becomes about 90% or more. Each of these CNTs has a hollow portion inside and a closed distal end.

FIG. 3 shows an electron micrograph obtained by magnifying a coating 22 covering the substrate 21 by 120,000 times in a state wherein the distal end of each CNT is open.

A method of manufacturing an electron emission source like the one described above will be described next.

First of all, the substrate 21 is formed in a lattice-like shape from a thin 42-6 alloy plate having a thickness of 0.05 to 0.20 mm by using a known photoetching technique. Note that iron or an alloy containing iron can be used for the substrate 21. As an alloy containing iron, for example, a stainless steel such as SUS304 or 42 alloy may be used. When iron is to be used, industrial pure iron (99.96Fe) is used. However, the purity is not limited to a specified purity, and for example, the purity may be 97% or 99.9%.

The CNT coating 22 is then formed on the lattice-like substrate 21 by using the thermal CVD method.

First of all, the substrate 21 is placed in a reaction vessel of a thermal CVD apparatus, and the vessel is evacuated to a pressure of about 1 Pa.

The substrate 21 is then heated by a heating means such as an infrared lamp and stabilized at a predetermined temperature. Thereafter, a gas mixture containing hydrogen gas and methane gas at a predetermined mixing ratio is introduced into the reaction vessel, and the substrate 21 is held in the reaction vessel for a predetermined period of time while the gas mixture flows and the pressure in the vessel is kept at 1 atm. In this case, the temperature of the substrate 21 is kept at 850° C., and the methane gas and hydrogen gas are supplied such that the methane gas concentration becomes 30%. This condition is held for 60 min.

With this processing, CNTs are grown on the surface of the substrate 21 and the wall surface of the metal portions (through hole walls 24) forming the lattice while curling like wool, thereby forming the coating 22 which is formed from CNT fibers and has a smooth surface.

In this embodiment, methane and hydrogen were used as a carbon introduction gas and growth promotion gas, respectively.

After a predetermined period time has elapsed and a CNT coating is formed, the supply of hydrogen gas and methane gas is stopped, and the reaction vessel is evacuated again. Thereafter, a gas mixture containing oxygen and inert gas with an oxygen concentration of 5 to 30 vol % is introduced into the vessel. At the same time, the substrate 21 on which the CNT coating is formed is heat-treated at a temperature of 520 to 850° C. for 5 to 20 min. At this time, the total pressure of the gas mixture is almost equal to atmospheric pressure. With this heat treatment, only the distal end portion of each CNT is burnt to form an opening portion.

The relationship between the pressure of a gas mixture, the oxygen concentration, the heating temperature, and the heating time is the same as that in the first embodiment.

Assume that the conditions for the above heat treatment are set such that in an atmosphere with an oxygen concentration of 5 to 30 vol %, the heating temperature is 600 to 800° C. and the heating time is 10 to 15 min. In this case, even if either a glass substrate or a metal substrate is used, heat treatment can be properly done.

In this case, methane gas is used as a carbon introduction gas. However, the present invention is not limited to this, and another gas containing carbon may be used. For example, carbon monoxide may be used as a carbon introduction gas. In this case, the lattice-like substrate 21 may be held in the reaction vessel for 30 min while the substrate 21 is heated to 650° C., carbon monoxide and hydrogen gas are supplied with a carbon monoxide concentration of 30%, and the reaction vessel is kept at 1 atm.

Alternatively, carbon dioxide may be used as a carbon introduction gas. In this case, the lattice-like substrate 21 may be held in the reaction vessel for 30 min while the substrate 21 is heated to 650° C., carbon dioxide and hydrogen gas are supplied with a carbon dioxide concentration of 30%, and the reaction vessel is kept at 1 atm.

The electron emission source manufactured in the above manner has an open distal end, and hence can emit a larger number of electrons. In addition, by using the thermal CVD method, an electron emission source can be formed, which has a large area covered with CNTs that curl and are intertwined with each other and a smooth surface. Since this electron emission source has a smooth surface, an electric field can be uniformly applied. If, therefore, this electron emission source is used as the electron source of a fluorescent display apparatus, field electrons are uniformly emitted from carbon nanotubes regardless of the positions. As a consequence, the emission density distribution on the phosphor screen caused by electron irradiation becomes extremely uniform, thus improving the display quality. In addition, the electron irradiation density on the phosphor screen which is set to obtain the same luminance as in the prior art is uniformly suppressed low. This makes it possible to avoid the problem that when the electron irradiation is nonuniform, the luminous efficacy of a portion to which an excessive irradiation current is supplied deteriorates quickly, thus obtaining long-life, high-efficiency, high-quality surface emission.

[Third Embodiment]

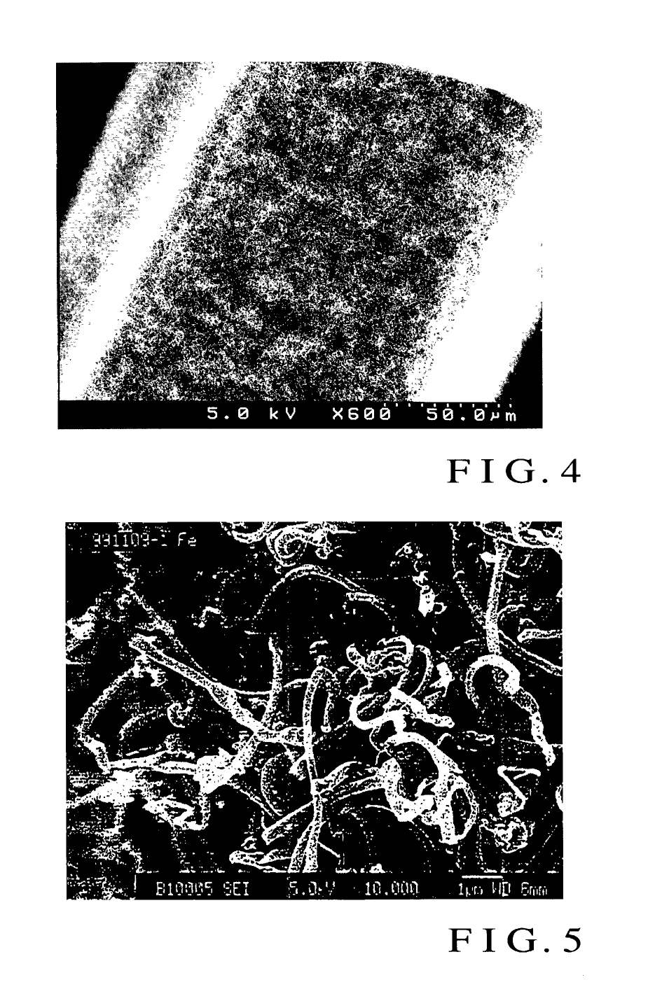

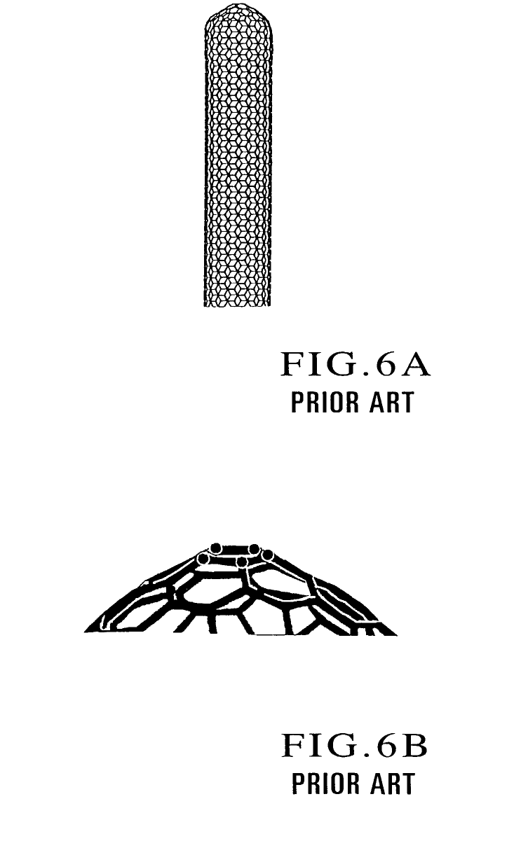

An electron emission source according to the third embodiment of the present invention will be described next with reference to FIGS. 4 and 5. Note that the same reference numerals as in the second embodiment denote the same parts of the electron emission source in the third embodiment, and a detailed description thereof will be omitted.

In the electron emission source according to this embodiment, CNTs extend vertically from the surface of a lattice-like substrate 21 having the same shape as that of the electron emission source according to the second embodiment and a through hole wall 24. That is, in this embodiment, CNTs forming a coating 22 extend vertically without curling. Note that “extend vertically” indicate, taking a metal portion of the lattice as an example, that CNTs extend upward from the upper surface of the metal portion, extend downward from the lower surface, and extend laterally from the side surfaces.

FIG. 4 shows the electron micrograph obtained by photographing the coating on the surface of this electron emission source from above. The magnification of this micrograph is 200 times. Since CNTs extend vertically from the surface, they look like white points in FIG. 4. FIG. 5 shows the electron micrograph obtained by obliquely photographing the coating on the surface of this electron emission source. The magnification of the micrograph is 10,000 times. As is obvious from FIG. 5, the electron emission source according to this embodiment is covered with a coating of carbon nanotubes extending vertically from the surface of the lattice-like substrate 21.

The above electron emission source can be manufactured by forming a CNT coating on the lattice-like substrate 21 using the microwave plasma CVD method.

Note that iron or an alloy containing iron that forms the substrate 21 functions as a catalyst when a CNT coating is formed by using the CVD method. In this embodiment, in consideration of manufacturing cost and availability, a thin plate made of a thin 42-6 alloy plate having a thickness of 0.05 to 0.20 mm is used, and through holes 23 are formed in the plate by photoetching as in the second embodiment.

A plasma CVD apparatus used for the plasma CVD method is an apparatus which has, in a reaction vessel, an lower electrode on which the substrate 21 is to be mounted, and an upper electrode facing the lower electrode, and supplies microwaves while introducing a reaction gas into the reaction vessel to form a plasma, thereby processing the substrate 21.

First of all, the substrate 21 is mounted on the lower electrode placed in the reaction vessel of the plasma CVD apparatus, and the reaction vessel is evacuated to a predetermined pressure. Hydrogen gas is then introduced into the reaction vessel.

After the hydrogen gas is introduced, microwave power is supplied into the reaction vessel to generate a plasma. In addition, a bias voltage is applied to the upper and lower electrodes in the reaction vessel to generate a parallel electric field with its negative side located on the lower electrode on which the substrate 21 is mounted. The surface of the lattice-like substrate 21 is then cleaned and activated by ion bombardment. At this time, the making microwave power and bias application voltage are respectively set to 500 W and 150 V, and the substrate 21 is processed for 15 min at a pressure of 1,000 Pa. Although it is not absolutely necessary to clean and activate the surface of the substrate 21, this process is preferably done because the electron emission properties of generated carbon nanotubes improve.

After methane gas and hydrogen gas are introduced into the reaction vessel at a predetermined ratio, microwave power is supplied into the reaction vessel to generate a plasma. In addition, a bias voltage is applied to the upper and lower electrodes to generate a parallel electric field with its negative side located on the lower electrode mounted on the substrate 21, thereby growing a CNT coating on the surface of the substrate 21 and the wall surfaces (through hole walls 24) of the metal portions that form the lattice. At this time, the substrate 21 is processed for 30 min while the making microwave power is set to 500 W, the bias application voltage is set to 250 V, the pressure is set to 200 to 2,000 Pa, and the methane gas concentration is set to 20%. At this time, the lattice-like substrate 21 is heated to a temperature of 500 to 650° C. by the microwave. If no bias voltage is applied, no CNT is formed, and a graphite coating is formed. Therefore, it is essentially necessary to apply a bias voltage.

After a predetermined period time has elapsed and a CNT coating is formed, the supply of hydrogen gas and methane gas is stopped, and the reaction vessel is evacuated again. Thereafter, a gas mixture containing oxygen and inert gas with an oxygen concentration of 5 to 30 vol % is introduced into the vessel. At the same time, the substrate 21 on which the CNT coating is formed is heat-treated at a temperature of 520 to 850° C. for 5 to 20 min. With this heat treatment, only the distal end portion of each CNT is burnt to form an opening portion.

In the electron emission source manufactured in the above manner, since the CNTs extend vertically from the surface of the substrate 21, when a high voltage is applied between the electrodes facing the lattice-like substrate 21, an electric field is concentrated on the distal end of ach carbon nanotube, and field emission of electrons occurs from the distal end. In this case, since the distal end portion of the CNT is open, a larger number of electrons can be emitted than in the prior art at the same electric field strength.

In addition, by using the plasma CVD method, an electron emission source having a smooth surface can be formed, in which a large area is covered with CNTs growing vertically from the wall surface of the metal portions of the substrate 21. As described above, since the electron emission source has the smooth surface, an electric field is uniformly applied to the surface. Therefore, uniform field electron emission with a high current density can be realized, and a destructive phenomenon due to local concentration of an electric field dose not easily occur. If, therefore, this electron emission source is used as an electron source for a fluorescent display apparatus, field electron emission uniformly occurs from the carbon nanotubes regardless of the positions. As a consequence, the emission density distribution on the phosphor screen which is caused by electron irradiation becomes extremely uniform, resulting in an improvement in display quality. In addition, since the electron irradiation density on the phosphor screen which is set to obtain the same luminance as in the prior art is uniformly suppressed low. This makes it possible to avoid the problem that when the electron irradiation is nonuniform, the luminous efficacy of a portion to which an excessive irradiation current is supplied deteriorates quickly, thus obtaining long-life, high-efficiency, high-quality surface emission.

In this embodiment, methane gas is used as a carbon introduction gas. However, the present invention is not limited to this, and another gas containing carbon may be used. For example, acetylene gas may be used as a carbon introduction gas. In this case, the same conditions as those in the above case wherein methane gas is used can be set except that the ratio between acetylene gas and hydrogen gas is so set to make the acetylene gas concentration become 30%. Furthermore, the gas to be used to clean and activate the surface of the substrate 21 is not limited to hydrogen gas, and a rare gas such as helium or argon may be used.

[Fourth Embodiment]

In the fourth embodiment of the present invention, CNTs are manufactured from a carbon introduction gas by the thermal CVD method or the like using a metal power containing at least one of iron, nickel, and cobalt as a catalyst, and openings are formed in the distal ends of these CNTs by heat treatment. Since the conditions for heat treatment to open the distal end portions have been described in the other embodiments described above, a description thereof will be omitted.

The CNTs obtained in this manner are mixed in a paste, and the paste is applied on the cathode electrode. The resultant structure is then calcined to obtain an electron emission source. In this case, the distal end portions of all the CNTs need not be open, and at least about 10% of all the CNTs may have open distal end portions.

According to the present invention, since the distal end portion of the CNT is open, a larger number of electrons can be emitted from the CNT than from the CNT having a closed distal end portion at the same electric field strength. This makes it possible to obtain a more efficient electron emission source.

In addition, as compared with the case wherein CNTs having closed distal ends are used, a lower electric field strength is required to emit the same number of electrons. As a consequence, the distance between the site of the electron emission source and the electron extraction electrode need not be extremely decreased. This relaxes the assembly precision requirement and allows simplification of the assembly process.

Furthermore, by performing heat treatment in an atmosphere containing a predetermined concentration of oxygen, CNT having open distal end portions can be obtained.

What is claimed is:

1. A carbon nanotube for an electron emission source, wherein
said carbon nanotube has a cylindrical shape formed from a plurality of graphite layers, the graphite layer being made of a six-membered ring of carbon, and
an outer diameter of the cylinder is 0.6 to 100 nm, a diameter of a hollow portion formed along an axis of the cylinder is 0.1 to 0.9 times the outer diameter of the cylinder, and the hollow portion has an open distal end portion.

2. A material for an electron emission source including a plurality of carbon nanotubes, wherein
at least 10% of said carbon nanotubes has a cylindrical shape formed from a plurality of graphite layers made of a six-membered ring of carbon, and
a diameter of a hollow portion formed along an axis of the cylinder is 0.1 to 0.9 times the outer diameter, and the hollow portion has an open distal end portion.

3. A material according to claim 2, wherein at least 10% of said carbon nanotubes is designed such that the cylinders have an outer diameter of 0.6 to 100 nm.

4. An electron emission source having a plurality of carbon nanotubes arrayed on a substrate, wherein
at least 10% of said carbon nanotubes is designed such that a diameter of a hollow portion formed along an axis of the cylinder is 0.1 to 0.9 times the outer diameter, and the cylinder has an open distal end portion.

5. A source according to claim 4, wherein at least 10% of said carbon nanotubes is designed such that the cylinders have an outer diameter of 0.6 to 100 nm.

6. A source according to claim 4, wherein the substrate covers a substrate made of a metal including at least iron.

7. A method of manufacturing an electron emission source, comprising:
the step of generating a deposit containing a carbon nanotube by causing arc discharge between carbon electrodes facing each other in an inert gas atmosphere; and
the step of heat-treating the deposit in an atmosphere of an oxygen concentration of 5 to 30 vol % at a temperature of 520 to 850° C. for 5 to 20 min.

8. A method of manufacturing an electron emission source, comprising:
the step of placing a base material made of a metal including at least iron in a material gas atmosphere containing a gas made of a carbon compound, and causing a chemical change in the material gas by externally applying energy thereto, thereby growing a carbon nanotube on a surface of the base material; and
the step of heat-treating the carbon nanotube covering the surface of the base material in an atmosphere of an oxygen concentration of 5 to 30 vol % at a temperature of 520 to 820° C. for 5 to 20 min.
